(19) United States
(12) Patent Application Publication
(10) Pub. No.: US 2009/0062004 A1
(43) Pub. Date: Mar. 5, 2009

(54) Input Terminal Emulator for Gaming Devices

(75) Inventor: Sriharsha Vedurmudi, Hyderabad (IN)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA Corporation, Santa Clara, CA (US)

(21) Appl. No.: 11/850,058

(22) Filed: Sep. 5, 2007

(51) Int. Cl. G06F 19/00; A63F 9/24

(52) U.S. Cl. 463/37

(57) ABSTRACT

A hand-held device (e.g., a mobile phone and/or a music/multi-media player) emulating a terminal of a gaming device. The hand-held device can be used to emulate different terminals such that the same hand-held device can be used to play with different gaming devices. In an embodiment, the user indicates the specific terminal type that is to be emulated, and the hand-held device generates buttons corresponding to the selected terminal type on a touch screen. In response to user actions on portions displaying the buttons, terminal inputs consistent with the interface requirements of the gaming device, are provided to the gaming port of a gaming device.

### BACKGROUND

1. Field of Disclosure

The present disclosure relates generally to gaming technologies, and more specifically to an input terminal for a gaming device.

2. Related Art

Gaming devices generally enable one or more users to play games. Games have a general purpose of entertainment (as opposed to being directed primarily for productivity increases) for one or more users as is well known in the relevant arts.

Input terminals are generally provided associated with gaming devices, with input terminals enabling corresponding users to provide inputs to the game being played. In general, the input terminals enable interactivity with the gaming device (or the game) and the logic underlying the game provides different user experiences (visual, audio, mechanical, etc.) depending on the inputs provided.

### BRIEF DESCRIPTION OF THE DRAWINGS

Example embodiments will be described with reference to the following accompanying drawings, which are described briefly below.

FIG. 1 is a block diagram illustrating an example gaming system in which various aspects of the present invention may be implemented.

FIG. 2 illustrates the display presented on a touch screen, in one embodiment.

FIG. 3 is a block diagram illustrating the details of hand-held device emulating a terminal for a gaming system in an embodiment of the present invention.

FIG. 4 is a flowchart illustrating the operation of a processing system enabling terminal emulation in an embodiment.

FIG. 5 depicts various configuration data that may be stored in an embodiment of a hand-held device providing for terminal emulation.

FIG. 6 is a block diagram illustrating the details of a gaming device in an embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

A hand-held device provided according to an aspect of the present invention emulates a terminal of a gaming device. Emulating a terminal implies that the hand-held device would enable a user to interact with the hand-held device similar to how s/he would interact with the terminal, and then generate similar signals as the terminal, consistent (in response to corresponding user actions) with the interface requirements of the gaming device.

In an embodiment, a user can select any of several types of terminals and the hand-held device emulates the selected terminal type. In particular, buttons representing the various keys of a terminal may be displayed on a touch screen, and terminal inputs are provided to the gaming device in response to touch actions on the respective portions (of the touch screen) at which the buttons are displayed.

As a result, users may use the same hand-held device to play games with different gaming devices. Alternatively, users may use the same hand-held device to emulate different terminal types for the same gaming device.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### 2. Example Environment

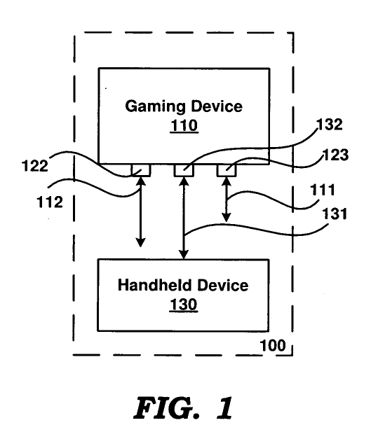

FIG. 1 is a block diagram of an example gaming system in which several aspects of the present invention may be implemented in an embodiment. Gaming system 100 is shown containing gaming device 110 and handheld device 130. Merely for illustration, only representative number/type of systems are shown in the Figure. Many environments often contain many more/fewer/different systems/components, both in number and type, depending on the purpose for which the environment is designed, as will be apparent to one skilled in the relevant arts.

For example, though shown as a stand-alone unit, multiple gaming devices may be communicatively coupled (e.g., by a network) and gaming device 110 may represent one of such devices. Implementations in such environments are also contemplated to be within the scope and spirit of various aspects of the present invention. Each block of FIG. 1 is described below in further detail.

Gaming device 110 implements a gaming logic corresponding to a desired game. In general, each gaming logic is designed to provide different user experiences responsive to different (sequences of) user inputs from one or more users. However, the user inputs are received as different terminal inputs according to a pre-specified convention/protocol on ports 122, 123 and 132. The terminal inputs represent (in digital or analog form) input signals expected in gaming device 110 on the corresponding ports. Each terminal input may be ‘state-based’ (i.e., depend on the prior user inputs and/or prior game outputs received from gaming device 110) or ‘state-less’ (simply reflect the user inputs at terminal in a pre-specified short duration) depending on the design of the game and gaming device 110.

As noted above, at least some of the terminal inputs may be received on gaming ports 122, 132 and 123 (on respective communication paths 112, 131 and 111). Each port represents a hardware circuit/component/portion, which provides the appropriate electrical and other protocol interfaces using which input and/or output signals are received on the corresponding communication path. Each port can be bi-directional or uni-directional as suited for the specific game. Port 132 and path 131 combination may be implemented as a wired or wireless communication link using appropriate interfaces (for example, USB, wired or wireless Ethernet, RS232, FireWire, RS-485, IEEE 802.11, Bluetooth, etc.) well known in the relevant arts. Each gaming port is assumed to interface with a single terminal merely for illustration.

The gaming device may contain various other input and/or output ports (e.g., an interface to an external display unit for output signals, a keyboard for administration, specialized terminals for game specific inputs and/or outputs, etc.) and supporting components (e.g., a display unit or audio card integrated within gaming device), though not shown in FIG. 1 for conciseness. Gaming device 110 may be implemented (or extended/adapted) using products such as Xbox™ from Microsoft Corporation (USA), PlayStation from Sony Corporation, etc. However, gaming device 110 may implement various other games (designed in future/past/present).

Handheld device 130, provided according to an aspect of the present invention, emulates a terminal (not shown) of gaming device 110. Thus, hand-held device 130 enables one or more users to provide user inputs and translates the user inputs to terminal inputs according to the protocol with which gaming device 110 is designed. The terminal inputs are provided on port 132.

To enable a user to provide inputs, handheld device 130 includes a touch-sensitive screen, which is potentially configurable by users to use handheld device 130 with different gaming devices (each potentially implementing a different game). Touch-sensitive screen (touch screen) refers to a display screen, which is designed to detect touch actions (on its surface) and provide corresponding signals for further processing. For example, data indicating one or more touch actions such as the points touched and point touch delay (i.e., how long was the point touched), etc., may be provided for further processing.

Handheld device 130 can be programmed to be operable with different games potentially on different gaming devices according to an aspect of the present invention. Part of such programmability entails adapting the display on the touch screen as suited for the specific game. The description is continued with respect to an example adaptation.

### 3. Example Display on Touch Screen

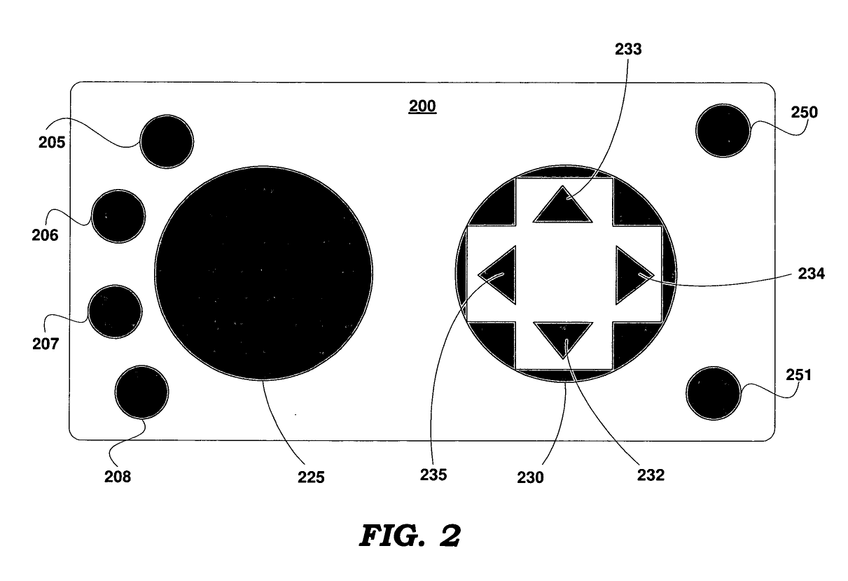

FIG. 2 illustrates the display presented on a touch screen assuming a game of interest requires a user to press one or more of up, down, left and right buttons, and further requires a user to select various options related to a war. However, different displays as suited for the specific games may be provided without departing from the scope and spirit of various aspects of the present invention. Such different displays may include more/fewer buttons (or other suitable form of indicating the required user inputs) of different types.

In general, each terminal may be viewed as containing various input elements (e.g., keys, joy stick, touch pad, etc) which are operated by a user to participate in a game. According to an aspect of the present invention, each input element (of the terminal) is represented on a corresponding portion of the touch screen (referred to below as a button) and a user operates on each input element by appropriate touch actions within the portion. When an input element permits multiple actions, different touch actions may be agreed to equal corresponding actions according to any convention. To avoid obfuscating the features of the invention, some representative simple input elements (keys) are demonstrated below.

Touch screen 200 is shown with a display having buttons 205-208 on the left hand side, large button 225, direction buttons down 232, up 233, right 234 and left 235 and two buttons 250 and 251 on the right hand side. Broadly, direction buttons 232-235 are used to provide the corresponding direction input to an object (for example an animate character in a game such as a person, an animal, a bird, etc.), or an inanimate object (for example a vehicle, a weapon like a gun, etc.) in a game.

Buttons 205-208 may be assigned functions such as fire, change scene, change weapon, etc., as suited to a game (in the context of a war). Buttons 250 and 251 may be assigned functions such as on/off, reset, etc., though buttons 225, 250 and 251 also may be assigned functions similar to the ones for buttons 205-208 as related to playing the game. Alternatively, buttons 250 and 251 may be used for various configurations (programmability) described below. Other buttons may also be provided, as needed for such programmability.

In addition, handheld device 130 may be used as a multi-media player (play audio and/or video) (e.g., iPhone™ from Apple Corporation), and accordingly buttons 225 and 205-208 may be used to play music, while buttons 232-235 are used to play a game in parallel.

As the user performs various user actions by appropriate touch actions on touch screen 200, the rest of the hand-held device needs to be implemented to translate the touch/user actions to required terminal inputs in case of game related user inputs. The manner in which such features can be implemented is described below with examples.

### 4. Hand-Held Device

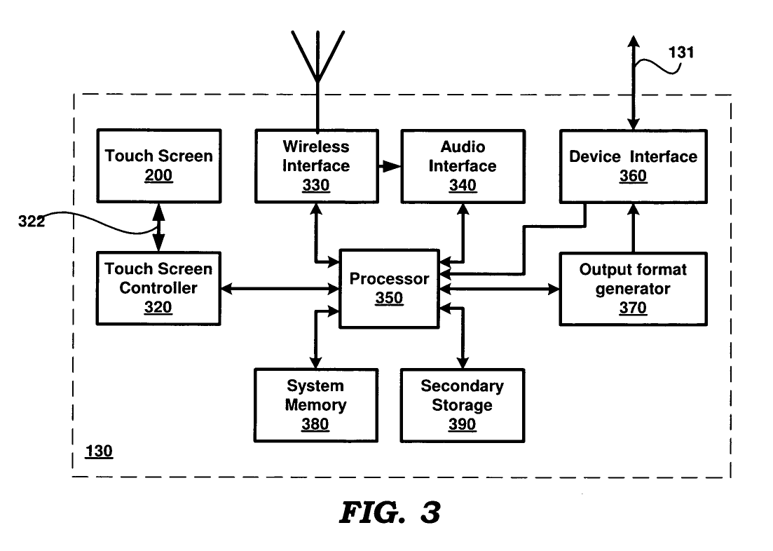

FIG. 3 is a block diagram illustrating the details of a hand-held device emulating a terminal for a gaming system in an embodiment of the present invention. Handheld device 130 is shown containing touch screen 200, touch screen controller 320, wireless interface 330, audio interface 340, processor 350, device interface 360, output format generator 370, system memory 380 and secondary storage 390. Each block is described in further detail below.

Merely for illustration, only representative number/type of blocks are shown in the Figure. Many environments often contain many more/fewer/different blocks, both in number and type, depending on the purpose for which the environment is designed, as will be apparent to one skilled in the relevant arts. For example, though the device is shown to operate as a multi-media player and a mobile phone, some of such features may be removed to implement the terminal using fewer components.

Wireless interface 330 provides the physical (antenna, etc.), electronic (transmitter, receiver, etc.) and protocol (GSM, CDMA, etc.) interfaces necessary for handheld device 130 to communicate with a wireless network (not shown). In an embodiment, processor 350 may enable a user to communicate through voice, SMS, data, email, etc., using a user interface (not shown) presented on touch screen 200. Many such interfaces will be apparent to one skilled in the relevant arts. Thus, handheld device 130 may optionally operate as a mobile phone (either in parallel to usage as a terminal or otherwise), in addition to Internet access device (for email and web-browsing).

Audio interface 340 provides an audio output (through an inbuilt speaker or externally pluggable ear phones, etc.) and an audio input (through an inbuilt or externally pluggable microphone, etc.). The audio interface may be used when handheld device 130 operates as a mobile phone (to capture voice signals for transmission and reproduce received voice signals).

In addition, audio interface 340 may generate the audio signals representing songs when appropriate signals are received from processor 350. Thus, handheld device 130 may optionally operate as a music player as well. In combination with display screen 200, handheld device 130 can operate as a multi-media player (playing combination of both video and audio signals, responsive to corresponding signals received from processor 350). The multi-media player also may operate either in parallel to usage as a terminal or otherwise.

Device interface 360 provides the physical, electrical and protocol interfaces necessary to communicate with gaming device 110. In general, device interface 360 needs to be designed to provide the terminal inputs to gaming device 110 via port 132 on communication path 131. Device interface 360 may be implemented using well known interfaces (for example, USB, wired or wireless Ethernet, Bluetooth, RS232, parallel interface, etc.) or may use proprietary interfaces used by gaming system manufacturers. The proprietary interfaces can differ in any of physical, electrical and protocol interfaces, and accordingly device interface 360 may have pluggable components to suit the corresponding gaming device. Any signals (e.g., audio) received from gaming device 110, for example, to enhance the user experience may also be received on path 131 and suitably reproduced.

System memory 380 contains randomly accessible locations to store program (instructions) and/or data, which are used by processor 350 during operation of handheld device 130. The data and instructions may be retrieved from secondary storage 390. The data retrieved may correspond to various configuration data (used to indicate the various buttons that need to be displayed as well as various terminal inputs that need to be generated in response to various user actions) for a game type the gaming system presently supports. The instructions, when executed, may similarly support the various applications (web-browsing, cell phone, multi-media player, etc.). System Memory 380 may contain RAM (e.g. SRAM, SDRAM, DDR RAM, etc.), non-volatile memory (e.g. ROM, EEPROM, Flash Memory, etc.) or both.

Touch screen controller 320 performs the operations necessary for the functioning of touch screen 200. Touch screen controller 320 receives (from processor 350) the data representing the text/graphics to be displayed on touch screen 200, and generates the corresponding display/control signals on path 322. The nature of signals depends on the implementation of touch screen 200 and controller 320 can accordingly be implemented in a known way.

In addition, touch screen controller 320 (in combination with the operation of touch screen 200) generates touch data indicating the various attributes (e.g., points touched, point-touch-delay, etc.) of touch actions sensed on touch screen 200. As described below, the touch data forms the basis for detection of various user inputs, which in turn form the basis for terminal inputs provided to gaming device 110. The combination of touch screen controller 320 and touch screen 200 can be implemented in a known way. Though shown as a separate unit from processor 350, touch screen controller 320 may be integrated into processor 350 as a single unit.

Output format generator 370 translates user actions into terminal inputs suited for gaming device 110. The implementation of output format generator 370 generally needs to be consistent with interface requirements of gaming device 110. Thus, the interface requirements (in terms of signal content, format, etc.) may be carefully studied and output format generator 370 may accordingly be implemented.

In a simplistic scenario, for a button configured as a binary switch (a switch having two possible states i.e. on and off), output format generator 370 may receive a button “press” and the corresponding coordinates from processor 350 and translates the received coordinates and button “press” to a button_hit event. The button_hit event may then be provided to gaming device 110 through device interface 360 and path 131, consistent with the interface requirements of gaming device 110.

Other examples of translation may be converting “dragging” on touch screen 200 to a joystick movement defined as an angle (0-360 degrees) along with a value between −1 and +1, or a button press state to a direction (up, down, left, right or North, South, East, West etc.). Output format generator 370 may also be integrated into processor 350 as a single unit. In general, one or more of processor 350, touch screen controller 320 and output format generator 370 is referred to as a processing system.

Secondary storage 390 may contain hard drives, flash memory, removable storage drives, etc. Secondary memory 390 may store (on a non-volatile memory) the data and software instructions, which enable handheld device 130 to provide several features in accordance with the present invention.

In general, memory units (including RAMs, non-volatile memory, removable or not) from which instructions can be retrieved and executed by processors are referred to as a computer (or in general, machine) readable medium. These memory units represent controllers which control the operation of hand-held devices (to provide various features of the present invention described herein) when the instructions are executed by the processors. The memory units are accordingly referred to as a computer readable mediums, which control the operation of the terminal.

In general, processor 350 may execute the instructions using the data (both in secondary storage 390) to enable handheld device 130 to operate in conjunction with different gaming devices

Secondary storage 390 may store configuration data (including multiple tables) for various terminal types/games/gaming devices. For example, one table may indicate the specific portions (location and area) of screen 200 which are to be programmed as input elements in a corresponding screen configuration. Other tables may indicate the format in which data is to be provided to gaming device 110, input and output interface requirements for gaming ports 122, 123 and 132, etc. Each screen configuration (shown in FIG. 2) may be used in association with multiple games (as conventional joysticks, game-pads, etc., would be used) by appropriate specification of the configuration data.

Processor 350 at least in substantial respects controls the operation (or non-operation) of the various other blocks (in hand-held device 130) by executing instructions stored in system memory 380. Some of the instructions executed by processor 350 also represent various user applications (e.g., playing songs/video, making a telephone call, etc.) provided by device 130.

In general, processor 350 reads sequence of instructions from various types of memory medium such as system memory 380 and executes the instructions to provide various features of the present invention. The operation of processor 350 in an example embodiments is described below in further detail.

### 5. Example Implementation

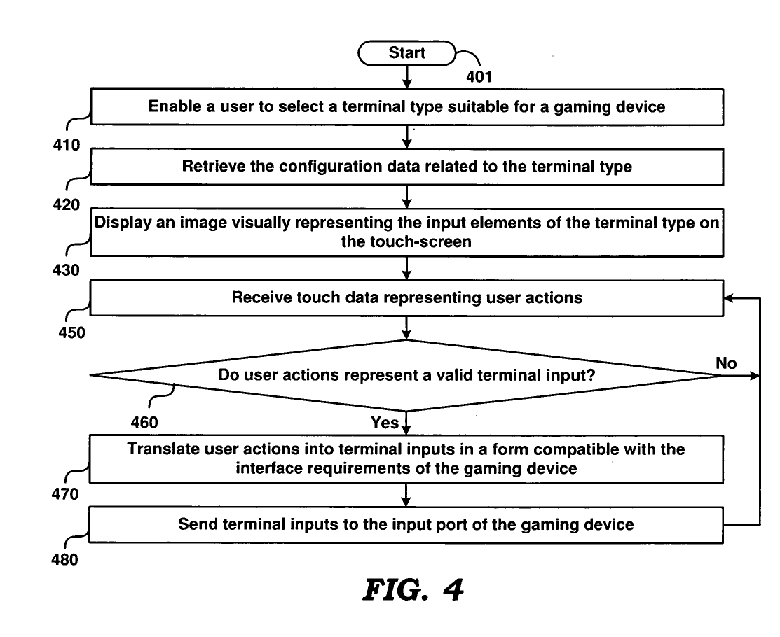

FIG. 4 is a flowchart illustrating the operation of a processing system of the input terminal in one embodiment of the present invention. The flowchart is described with respect to FIGS. 1-3 merely for illustration. However, various features can be implemented in other environments and other components. Furthermore, the steps are described in a specific sequence merely for illustration.

Alternative embodiments in other environments, using other components, and different sequence of steps can also be implemented without departing from the scope and spirit of several aspects of the present invention, as will be apparent to one skilled in the relevant arts by reading the disclosure provided herein. The flowchart starts in step 401, in which control passes immediately to step 410.

In step 410, processor 350 enables a user to select a terminal type suitable for a gaming device. Processor 350 may use a suitable user interface such as a menu presented on touch screen 200 to enable a user to select a terminal type (for example Microsoft sidewinder game pad) to be used for a game on gaming device 110. For example, processor 350 may present a list of gaming devices to the user. On the user selecting a gaming device, processor 350 may present a list of available terminal types, which are compatible with the selected gaming device and the user may select one of the available terminal types.

In step 420, processor 350 retrieves the configuration data related to the terminal type. As may be appreciated, configuration data for different terminal types may be stored in secondary storage 390 and the data related to the selected terminal type may be retrieved and stored in appropriate places (registers, variables, etc.). It should be appreciated that configuration data may also be received from other sources such as gaming device 110 through port 132 over path 131 or received through wireless interface 330 (for example from a web server), etc.

In step 430, processor 350 displays an image visually representing the input elements of the terminal type on the touch-screen. For example, if a user selects Sidewinder game pad (from Microsoft Corporation) as an input terminal for a game, an image of a Sidewinder game pad with the buttons, controls, text and other visual features (such as color schemes, texture, etc.), such that the image visually replicates (visually represents) the Sidewinder game pad, is displayed on the touch screen display.

At a different instance, the user may select Sega Dreamcast controller (from Sega Corporation) as input terminal for another game. An image of the Sega Dreamcast controller which visually replicates the Sega Dreamcast controller may then be displayed on the touch screen display. In case a general joy stick is selected as a terminal type, one portion may correspond to the press button (provided on the top of the joy stick) and another portion (with or without overlap with the first portion) may correspond to the Joy Stick motions in various directions.

In step 450, processor 350 receives touch data representing user actions. A user may perform an action such as press, release, drag, etc., on touch screen 200 (having visual representation of the selected input terminal type). Processor 350 receives the user action from touch screen controller 320. In one embodiment, processor 350 may receive the user action as two positive integers representing the coordinates of the location on the touch screen display where the user action occurred, and a logical value (in the form of a “0” or a “1”) representing a press state. A press state “1” may indicate that a “press” (or a “touch” on the touch screen) is occurring currently at the location indicated by the coordinates received, whereas a press state “0” may indicate that the “press” has been removed (touch screen not being “touched” any more). It should be appreciated that processor 350 may receive the touch data in other formats, well known in the relevant arts.

In step 460, processor 350 checks whether the user actions represent a valid terminal input. For example, processor 350 may check whether the “press” has lasted for a predetermined length of time (to prevent spurious “press” states). Processor 350 may also check whether a user input element such as a button or control is located at the coordinates, where the user action occurred. If both checks are found to be correct, the “press” is a valid terminal input and processor 350 provides the user action to output format generator 370. If the checks are not found to be correct, it is not a valid terminal input. If the user action is found to be a valid terminal input, processing continues to step 470. Otherwise, control goes back to step 450.

In step 470, output format generator 370 translates user actions into terminal inputs in a form compatible with the interface requirements of the gaming device. In step 480, device interface 360 sends the terminal input(s) on path 131 to gaming device 110. The loop of steps 450-480 may continue to process various press actions encountered by touch screen 200.

The example embodiment above thus operates on various definitions within the configuration data. As more terminal types evolve as suited for specific games (to be designed), the configuration data may simply need to be changed to correspond to the terminal type. The content of example configuration in an embodiment is described below in further detail.

### 6. Configuration Data

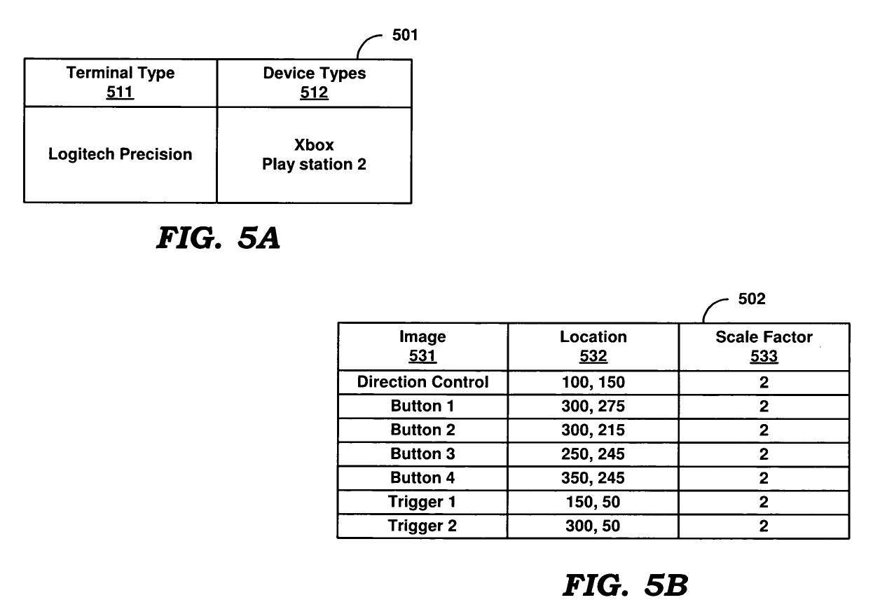

FIG. 5 depicts logically the configuration data stored in secondary memory 390 in one embodiment. Table 501 contains two columns—terminal type 511 and device types 512. Each row is shown dedicated for one terminal type and the specific gaming devices to which the terminal type is suited for. The data in the table may be used as a basis for providing a suitable user interface using which a user may specify a terminal type (as noted above in step 410). It should be appreciated multiple rows may be present for the same terminal type, for example, to suit the preferences of different users.

Table 502 may be provided for each terminal type. Table 502 is shown containing three columns—image 531, location 532 and scale factor 533. Image 531 represents the visual representation of the button(s) noted above with respect to FIG. 2, and location 532 may indicate the pixel position (on the entire area of touch screen 200) at which the center of the image is to be placed. Scale factor 533 indicates the factor by which image 531 should be scaled prior to display in the corresponding area, and can be different for different devices/games/users, etc.

Additional configuration data may also be maintained in secondary memory 390 to assist in emulation and/or to simply the usability of the terminal provided according to various aspects of the present invention, as described below.

### 7. More Configuration Data and its Use

This section illustrates the manner in which the user input is acquired and transformed by handheld device 130 emulating a terminal, into a terminal input that is compatible with gaming device 110. The visual representation of the terminal being emulated may contain the following types of elements.

A. Digital buttons: These are graphics (in any desired shape) representing input elements of a terminal. In an embodiment, each button has a defined centre and maximum allowable extent (for example, a square with its centre at pixel positions (100,100) and whose extent is 25 pixels). When a user acts on such an input element, either a 1 (for pressed state) or 0 (for not pressed state which also represents a released state after a pressed state) may be generated by output format generator 370.

B. Uni-directional push buttons: These are graphics (in any shape) representing another set of input elements of a terminal, with a defined centre and maximum allowable extent. When a user acts on such an input element, a floating point number between 0 and 1 (both inclusive) may be generated by output format generator 370.

C. Bi-directional push buttons: These are graphics (in any shape) representing yet another set of input elements of a terminal, with a defined centre and maximum allowable extent. When a user acts on such an input element, a floating point number between −1 and 1 (both inclusive) may be generated by output format generator 370.

Tables 1-4 represent the manner in which configuration data may be stored for a terminal being emulated, in an example embodiment. Table 1 represents the configuration data necessary to define the graphics for a button (input element) of a terminal being emulated on handheld device 130. Configuration data as per Table 1 may be stored for each button of the terminal being emulated. Processor 350 may create a visual representation of a button on touch screen 200 using the data retrieved from the corresponding configuration table storing information as shown in Table 1.

TABLE 1
Button Design Details

| Table Element | Description |
|---|---|
| ButtonName | Name of the Button |
| ButtonType | Type Of Button. |
| | 0 Digital, |
| | 1 Uni-directional, |
| | 2 Bi-directional |
| ButtonCentreX | X co-ordinate of the center of the button |
| ButtonCentreY | Y co-ordinate of the centre of the button |
| ButtonBoundayPlusX | Maximum positive X-axis |
| ButtonBoundaryPlusY | Maximum positive Y-axis |
| ButtonBoundaryMinusX | Maximum negative X-axis |
| ButtonBoundaryMinusY | Maximum negative Y-axis |
| ButtonStepX | Indicates (in pixels) the difference |
| | between two successive touch-points |
| ButtonStepY | Indicates (in pixels) the difference |
| | between two successive touch-points |
| ButtonAllowedFreedom | 0 X-axis |
| | 1 Y-axis |
| ButtonOutputScale | Number of divisions between −1/0 and |
| | +1 |

Table 2 represents the configuration data for a terminal being emulated by handheld device 130. Table 2 identifies the name of the terminal being emulated (Table element “Terminal Name”) and the number of buttons of each of the three types (digital, uni-directional and bi-directional) described above stored in table elements “DigitalButtons”, “UniDirButtons” and “BiDirButtons” respectively.

Table 2 also stores pointers to a linked list of all button design details contained in configuration data (as shown in Table 1) for each of the three types of buttons described above. For visually representing a terminal on handheld device 130, processor 350 may retrieve the configuration data for each of the buttons from the respective linked lists and create the graphics for the respective buttons on touch screen 200.

TABLE 2
Pre-built Terminal button assignment:

| Table Element | Description |
|---|---|
| Terminalname | Name of the terminal |
| DigitalButtons | Number of digital buttons |
| UniDirButtons | Number of uni-directional buttons |
| BiDirButtons | Number of bi-directional buttons |
| DigitalButtonsPtr | Pointer to a linked list of all button |
| | detail tables (linked list of table 1 rows) |
| UniDirButtonsPtr | Pointer to a linked list of all button |
| | detail tables (linked list of table 1 rows) |
| BiDirButtonsPtr | Pointer to a linked list of all button |
| | detail tables (linked list of table 1 rows) |

Table 3 represents the configuration data naming the terminal that may be used with a gaming device.

TABLE 3
Console-Controller mapping

| Table Element | Description |
|---|---|
| ConsoleName | Name of the gaming device |
| Terminalname | Name of the terminal |
| | (as in table 2) |

Table 4 represents the manner in which the current value corresponding to each button may be stored prior to providing the values to gaming device 110. Each button of the terminal being emulated may have an output table as shown in Table 4 to store its current value.

TABLE 4
CurrentOutputTable

| Table Element | Description |
|---|---|
| ButtonName | Name of the button |
| CurrentValue | Current Value of the buttons output |

Handheld device 130 emulating a terminal may use data stored in Tables 1 and 2 to create visual representation of the terminal being emulated on touch screen 200. Communication needs to be established between gaming device 110 and handheld device 130 through port 132 over path 131 so that terminal inputs generated as a result of user action on touch screen 200 may be sent to gaming device 110.

In one embodiment, gaming device 110 repeatedly sends a detect signal (for example a hexadecimal value 0xAA) on all its ports once every 100 milli-seconds until it receives a response from one or more ports 122, 123 and 132. Handheld device 130, emulating a terminal compatible with gaming device 110, repeatedly checks path 131 for the detect signal from gaming device 110. Then, handheld device 130 sends a present signal (for example, a hexadecimal value 0x55) to gaming device 110, thus establishing communication between gaming device 110 and handheld device 130. As a next step, gaming device 110 may request the handheld device 130 for the number of buttons available, using a query signal (for example, a hexadecimal value 0x01).

Handheld device 130 may respond with a sequence of three bytes, each byte indicating how many buttons of each of the three types it is configured for. Assuming, for example, that the terminal being emulated has 6 digital buttons, 1 uni-directional button and 1 bi-directional button, handheld device 130 may respond with three bytes with hexadecimal values 0x6, 0x1 and 0x1, corresponding to the number of digital, uni-directional and bi-directional buttons. After receiving the number of each type of buttons from handheld device 130, gaming device 110 is ready to accept terminal inputs from handheld device 130.

On a user pressing any portion of touch screen 200, an interrupt may be generated for touch screen controller 320 to provide the coordinates of the point pressed/released and nature of user action (pressed/released) to processor 350. While the description is continued assuming that touch screen controller 320 may provide the coordinates for only one point pressed by a user, it should be appreciated that touch screen controller 320 may provide multiple coordinates if multiple points are simultaneously pressed by a user, and such multiple coordinates emanating from multiple simultaneous presses by a user may also be converted into terminal inputs in a similar manner, as will be apparent to one skilled in the relevant arts by reading the disclosure provided herein. For the purpose of illustration, it is assumed that the buttons (input elements) are capable of motion along a single axis, for example, up-down or left-right.

Processor 350 may check whether the user action (indicated by the received coordinates and nature of user action) represent a valid terminal input, as described before in section 5. If it is not a valid terminal input, the received data is discarded. If it is a valid terminal input, then output format generator 370 generates the terminal inputs as described below.

If the input element is a digital button, then the value for the corresponding digital button is set to 1 if the nature of the user action is “pressed” and 0 if the nature of the user action is “released”. The values for other buttons are set to 0 (released)

If the input element is a uni-directional push button, then output format generator 370 generates the terminal inputs as follows:

Assume the centre co-ordinates of the input element displayed on touch screen 200 are (X0,Y0) and the coordinates received by processor 350 from touch screen controller 320 are (X1,Y1). Also assume that Xt and Yt are the boundaries along x-axis and y-axis (with reference 0,0 coordinates) respectively for the input element displayed on the touch screen and the user is allowed only one degree of freedom (say x axis). Further, the output of 0 to 1 is with a decimal precision of n (for example, if n=3, then the possible values will be between 0.000 and 1.000).

Terminal Input=((10̂n)/Xt)*(X1−X0)

If the input element is a bi-directional push button, then output format generator 370 generates the terminal inputs as follows:

Assume the centre co-ordinates of the input element displayed on touch screen 200 are (X0,Y0) and the coordinates received by processor 350 from touch screen controller 320 are (X1,Y1). Also assume that Xt and Yt are the boundaries along x-axis and y-axis respectively for the graphic button and the user is allowed only one degree of freedom (say y-axis). Further, the output of −1 to 1 is with a decimal precision of n (for example, if n=4, then the possible values will be between −1.0000 to +1.0000).

Terminal Input=((10̂n)/Yt)*(Y1−Y0)

The terminal input generated by output format generator 370 in the manner described above, is stored in output table 4 (described above) and provided to gaming device 110 over path 131 when gaming device 110 requests for the terminal inputs.

Thus, by using the appropriate configuration data, hand-held device 130 can be used in conjunction with various gaming devices. The description is continued with respect to a gaming device in one embodiment.

### 7. Gaming Device

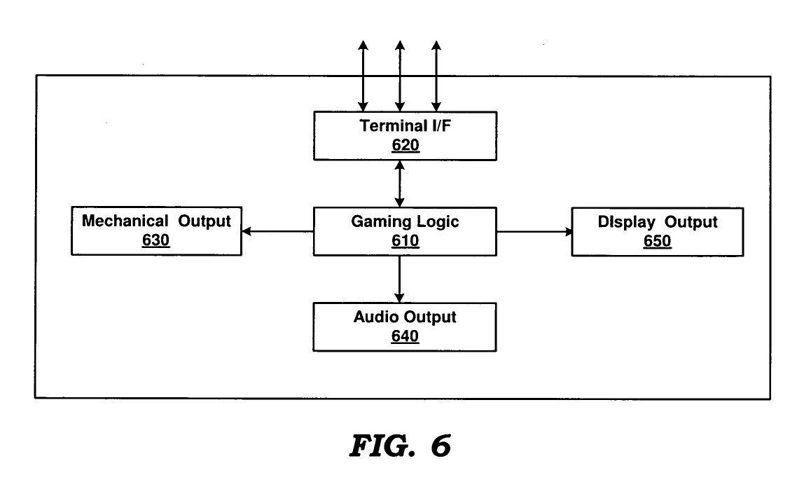

FIG. 6 is a block diagram illustrating the details of gaming device 110 in one embodiment. Gaming device 110 is shown containing gaming logic 610, terminal interface 620, mechanical output 630, audio output 640 and display output 650. Each block is described below in further detail.

Terminal interface 620 receives various terminal inputs from different terminals (on the three shown ports in the example embodiment) and provides the corresponding information to gaming logic 610. Terminal interface 620 may provide a pluggable physical interface (at least on port 132) such that different hand-held devices can be plugged in and used in conjunction with the gaming device of FIG. 6.

Mechanical output 630, audio output 640 and display output 650 together are used to provide various user experiences corresponding to the game being played. Mechanical output 630 may provide for physical motions (e.g., vibrations) by interfacing with external mechanical components. Audio output and display output 650 may respectively be used to generate audio signals and visual images as a part of the user experience.

Gaming logic 610 receives various terminal inputs and provides a user experience corresponding to the game depending on different terminal inputs received. The gaming logic may be viewed as the brain of the game. Different terminal inputs (from different ports) may trigger different user experiences, constituting a game. In an embodiment, the terminals can only provide inputs and the gaming logic is designed to determine the user experiences corresponding to the game. The terminals would not receive any inputs from the gaming logic in such an embodiment and thus would not contain any “intelligence” related to the game.

In the illustrative example of above, gaming device 110 may request terminal inputs by sending a “data read” signal (for example, a hexadecimal byte 0x02) repeatedly (for example, every 10 milli seconds) to hand held device 130 (emulating a terminal). Hand held device 130 may retrieve the current value for each button (for example, 1 byte for each digital button and 4 bytes for each directional button assuming that a floating point number is represented by 4 bytes) from the respective output table and provide it to gaming device 110 over path 131. In the above example of a terminal with 6 digital buttons, one uni-directional button and one bi-directional button, handheld device 130 may respond to a “data read” request from gaming device 110 with 14 bytes (6 bytes consisting one byte each for each of the six digital buttons, 4 bytes for the uni-directional button and 4 bytes for the bi-directional button).

Thus, using the techniques described above, various hand-held devices (which are otherwise usable as one or more of mobile phones, music/video players, etc.) can be adapted to be used as terminal emulators for gaming devices. A user may carry such devices to different geographical locations and play with different gaming devices. Accordingly, providers of gaming devices may leave ports available for pluggability of the terminal emulators and enable users to play games.

### 8. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A gaming system enabling a set of players to play a game, said gaming system comprising:
a gaming device designed to receive a plurality of terminal inputs on a set of gaming ports, wherein said gaming device provides a user experience corresponding to said game to said set of players in response to receiving said plurality of terminal inputs on said set of gaming ports, said set of gaming ports including a first gaming port; and
a hand-held device designed to operate as a terminal emulator for said gaming device,
said hand-held device containing a touch-sensitive screen and being programmable to indicate a portion on said touch sensitive screen, a set of user actions and a first terminal input contained in said plurality of terminal inputs,
said terminal being designed to send said first terminal input in response to said set of user actions on said portion of said touch sensitive screen.

2. The gaming system of claim 1, wherein said hand-held device is designed to receive an input indicating whether the hand-held device is to emulate a first terminal type or a second terminal type, wherein said hand-held device provides said first terminal input only when said input indicates that the hand-held device is to emulate said first terminal type, but does not send said first terminal input even when said set of user actions are detected on said portion if said input indicates that the hand-held device is to emulate said second terminal type.

3. The gaming system of claim 1, wherein said hand-held device is pluggable into said gaming device such that said hand-held device can be transported to be used with gaming devices located in different locations.

4. The gaming system of claim 2, wherein said hand-held device also operates as a mobile phone.

5. The gaming system of claim 2, wherein said hand-held device also operates as a multi-media player.

6. A hand-held device emulating terminals of gaming systems, said hand-held device comprising:
a touch screen;
a device interface designed to be coupled to a gaming port of a gaming device, said gaming device being provided external to said hand-held device;
a memory to store configuration data indicating an input element that is associated with a terminal type; and
a processing unit displaying an image representing said input element on a portion of said touch screen and generating a terminal input in response to a set of user actions on said portion,
wherein said terminal input is provided by said device interface to said gaming device on said gaming port,
whereby a user provides said set of user actions on said portion to play a game provided by said gaming device.

7. The hand-held device of claim 6, wherein said configuration data further specifies a plurality of terminal types, wherein each terminal type is associated with a corresponding set of input elements,
wherein said processing unit is designed to receive a user input indicating a specific terminal type that is to be emulated by said hand-held device,
said processing unit examining said configuration data to determine a first set of input elements associated with said specific terminal type and displaying buttons corresponding to said first set of input elements on said touch screen in response to receiving said user input.

8. The hand-held device of claim 7, wherein said processing unit and said device interface together generate terminal inputs on said gaming port according to said specific terminal type in response to receiving said user input indicating said specific terminal type and in response to user actions on portions displaying said first set of input elements.

9. The hand-held device of claim 8, wherein said configuration data indicates locations on said touch screen at which buttons corresponding each of said first set of input elements is to be displayed, wherein said processing unit displays said buttons at locations specified by said configuration data.

10. The hand-held device of claim 9, wherein said device interface is designed to provide said terminal inputs according to one of FireWire, RS-485, IEEE 802.11, Bluetooth, USB, RS232 on said gaming port.

11. The hand-held device of claim 9, wherein one of said first set of input elements is designed indicate a direction to said gaming device.

12. A method of facilitating playing of games on gaming devices, said method comprising:
displaying an image visually representing a first input element of a terminal type on a touch-screen of a hand-held device, said first input element being displayed on a first portion of said touch screen;
receiving a touch data representing a set of user actions on said first portion;
translating said set of user actions into a terminal input in a form compatible with the interface requirements of said gaming device; and
sending said terminal input to a gaming port of a gaming device.

13. The method of claim 12, further comprising:
enabling a user to select a terminal type suitable for said gaming device;
retrieving a configuration data related to said terminal type from a memory, wherein said configuration data indicates said first portion and a type of said first input element,
wherein said displaying is based on said configuration data retrieved from said memory.
